(19) United States
(12) Patent Application Publication
(10) Pub. No.: US 2011/0308021 A1
(43) Pub. Date: Dec. 22, 2011

(54) Pipe Deburrer with Replaceable Tool Head

(76) Inventors: Kuo-Shen Yang, Nantou City (TW); Mei-Ling Lin, Nantou City (TW)

(21) Appl. No.: 12/820,634

(22) Filed: Jun. 22, 2010

(51) Int. Cl. B25F 1/04; B26B 27/00

(52) U.S. Cl. 7/157; 30/169

(57) ABSTRACT

A pipe deburrer with replaceable tool head comprises a working end the tool head of which can be replaced as desired, and the working end is provided with a control element to control the tool head to engage with or disengage from the inserting groove of the working end, thus improving the convenience in use, increasing the working efficiency while reducing the tool cost.

### BACKGROUND OF THE INVENTION

1. Field of the Invention

The present invention relates to a pipe deburrer, and more particularly to a pipe deburrer with replaceable tool head.

2. Description of the Prior Art

Referring to FIG. 1, a conventional pipe deburrer 40 which brings a raw material deburring tool and a screwing tool together comprises a working end 41 and an assembling end 42 that are oppositely arranged. Between the working end 41 and the assembling end 42 is formed an edge deburring portion 43. The pipe deburrer 40 is assembled to a power tool through the assembling end 42, and the edge deburring portion 43 is used to deburr the raw edge. The working end 41 can be used to screw screws. However, since the working end 41 has a fixed shape, it can only screw the fixed type of screws, so that if the type of to-be-screwed screw varies, it needs to use an additional corresponding screwing tool to deburr the screwing operation, thus not only increasing tool cost but causing inconvenience in use while reducing working efficiency.

The present invention has arisen to mitigate and/or obviate the afore-described disadvantages.

### SUMMARY OF THE INVENTION

The primary objective of the present invention is to provide a pipe deburrer with replaceable tool head which comprises a working end the tool head of which can be replaced as desired, and the working end is provided with a control element to control the tool head to engage with or disengage from the inserting groove of the working end, thus improving the convenience in user, increasing the working efficiency while reducing the tool cost.

To achieve the above objective, a pipe deburrer with replaceable tool head in accordance with the present invention comprises a working end and an assembling end, between the working end and the assembling end is formed a deburring portion, the working end including an inserting groove for insertion of the tool head, the deburring portion includes plural different sized engaging cylinders, and the respective engaging cylinders are arranged from the working end to the assembling end in diameter order from smallest to biggest, each of the engaging cylinders is provided with a deburring element at a side thereof, and each of the deburring elements is formed with a scraping opening, the assembling end is assembled to a power tool.

### BRIEF DESCRIPTION OF THE DRAWINGS

FIG. 1 is a perspective view of a conventional pipe deburrer;

FIG. 2 is an exploded view of a working end of a pipe deburrer with replaceable tool head in accordance with the present invention;

FIG. 3a is a cross-sectional view showing that the took head is not limited by the locating steel ball in accordance with the present invention;

FIG. 3b is a cross-sectional view showing that the tool head is limited by the locating steel ball in accordance with the present invention;

FIG. 4 is a perspective view showing that the deburring portion of the pipe deburrer with replaceable tool head in accordance with the present invention deburres the pipe element;

FIG. 5 is a perspective view showing that the working end of the pipe deburrer with replaceable tool head in accordance with the present invention fixing pipe element connecting assembly by use of screws; FIG. 6a is a cross-sectional view showing that the sliding sleeve in accordance with the present invention slides to a replacing position to make the locating steel ball release the tool head;

FIG. 6b is a cross-sectional view showing that the sliding sleeve in accordance with the present invention slides to a limiting position to make the locating steel ball limit the tool head; and

FIG. 7 is a perspective view showing that the tool head protrudes out of the working end in accordance with the present invention.

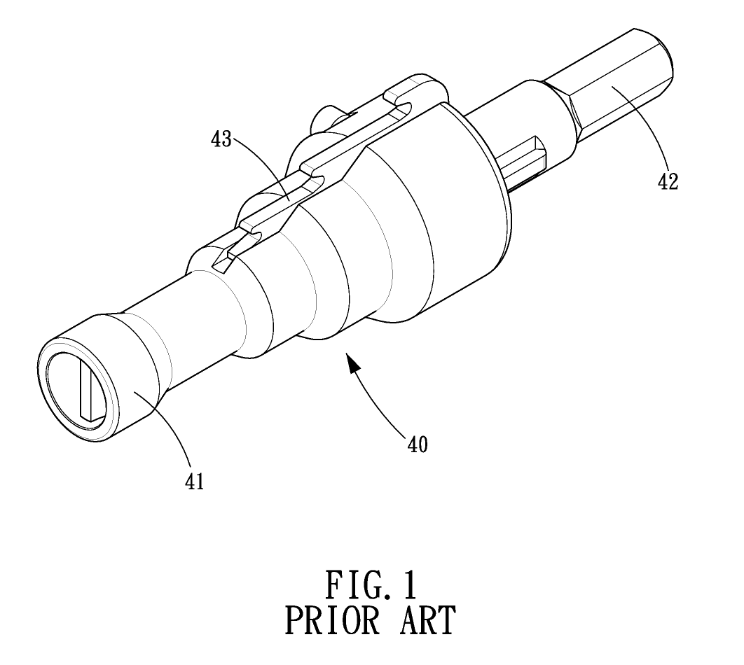

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

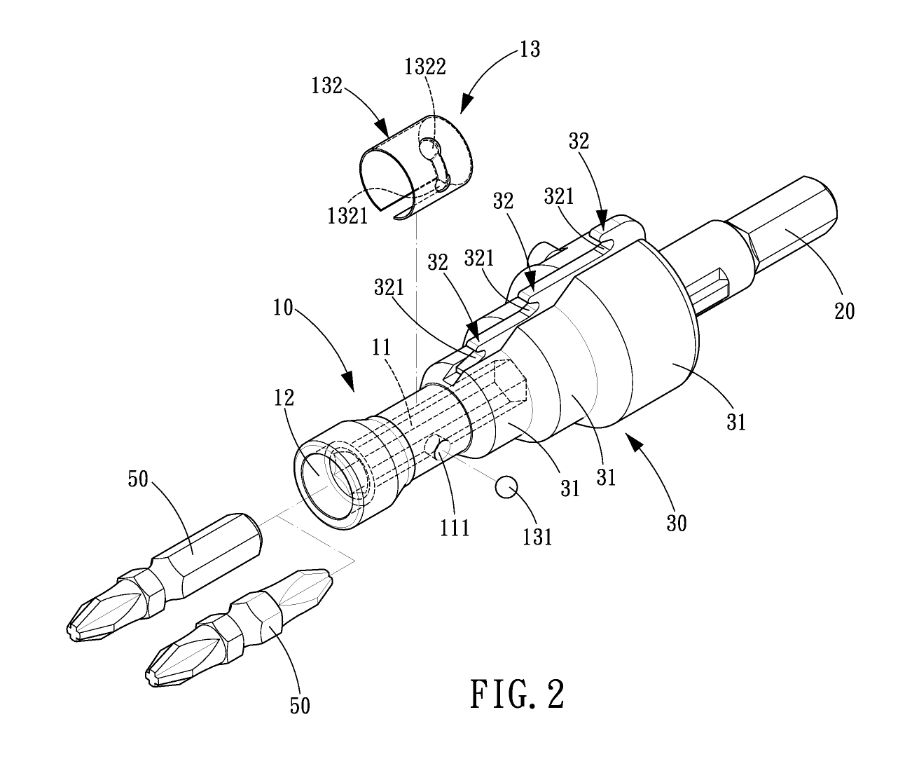

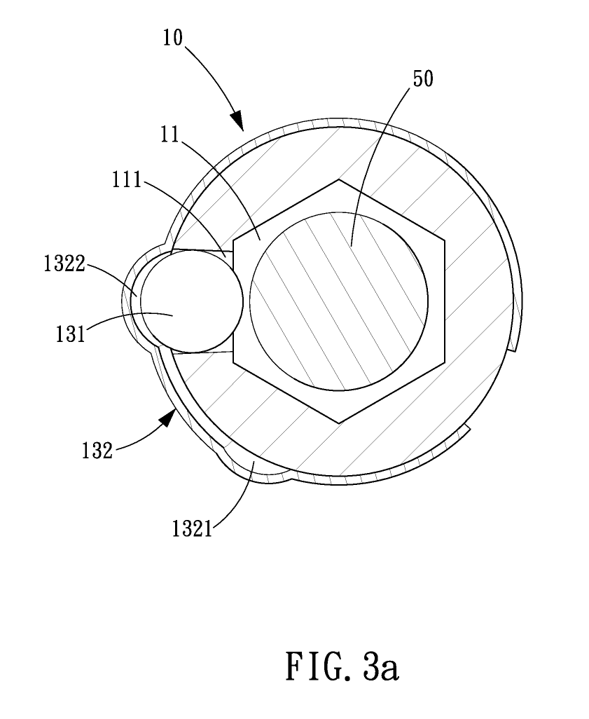

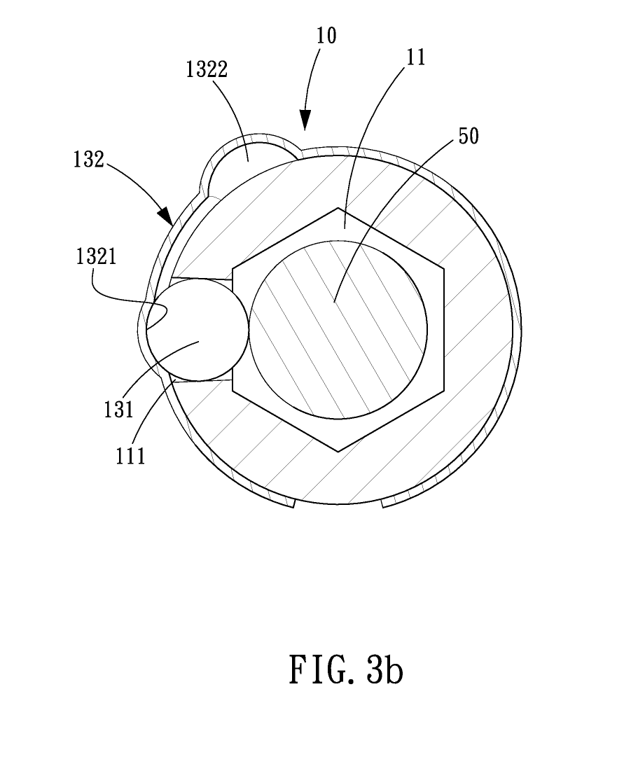

Referring to FIGS. 2, 3a and 3b, a pipe deburrer with replaceable tool head in accordance with a preferred embodiment of the present invention essentially comprises a working end 10 and an assembling end 20 that are oppositely arranged.

Between the working end 10 and the assembling end 20 is formed a deburring portion 30. The working end 10 includes an inserting groove 11 for insertion of the tool head 50. The working end 10 is further formed with an engaging opening 12 at an opening of the inserting groove 11, and an inner diameter of the engaging opening 12 is greater than an outer diameter of a head portion of a screw 71 screwed by the tool head 50, so that the screw 71 can be engaged in the engaging opening 12 during the screwing operation, facilitating the screwing operation. The deburring portion 30 includes plural different sized engaging cylinders 31, and the respective engaging cylinders 31 are arranged from the working end 10 to the assembling end 20 in diameter order from smallest to biggest. Each of the engaging cylinders 31 is provided with a deburring element 32 at a side thereof, and each of the deburring elements 32 is formed with a scraping opening 321. The assembling end 20 is assembled to a power tool.

The working end 10 is provided with a control element 13. A first end of the control element 13 extends out of the working end 10, and a second end of the control element 13 extends into the inserting groove 11 to engage with or disengage from the tool head 50 in the inserting groove 11. In the present embodiment, the inserting groove 11 is formed with a radial inserting hole 111, and the control element 13 of the working end 10 includes a locating steel ball 131 which is located in the radial inserting hole 111 and has a diameter bigger than the diameter of the radial inserting hole 111, and an elastic fastening element 132 which is rotatably mounted outside the inserting groove 11. The elastic fastening element 132 is C-shaped or U-shaped and formed with a first groove 1321 and a second groove 1322, and the first groove 1321 is smaller than the second groove 1322. The elastic fastening element 132 is shifted between a limiting position where the first groove 1321 is aligned with the radial inserting hole 111 to allow the locating steel ball 131 to be pushed against by the first groove 1321 to limit the tool head 50 and a replacing position where the second groove 1322 is aligned with the radial inserting hole 111 to allow the locating steel ball 131 to displace toward the second groove 1322 to release the tool head 50.

The aforementioned is the summary of the positional and structural relationship of the respective components of the preferred embodiment in accordance with the present invention.

For a better understanding of the present invention, its operation and function, reference should be made to the following description:

Referring to FIG. 2 again, since the working end 10 includes the inserting groove 11 for insertion of the tool head 50, the tool head 50 of the working end 10 can be replaced as desired according to the type of the screw 71 to be driven, improving the convenience in use. In the present embodiment, the tool head 50 is inserted in the inserting groove 11 of the working end 10 in such a manner that the working end of the tool head 50 is located at the engaging opening 12, facilitating the engagement of the screw 71 in the engaging opening 12.

In addition, referring to FIGS. 3a and 3b again, to replace the tool head 50, the elastic fastening element 132 will be rotated to the replacing position first, in other words, the elastic fastening element 132 will be rotated to align the second groove 1322 with the radial inserting hole 111 of the inserting groove 11, the second groove 1322 provides an accommodation space which is big enough for the locating steel ball 131 to displace toward the second groove 1322 to make the positioning steel ball 131 not limit the tool head 50 in the inserting groove 11 to allow the tool head 50 to be pulled out easily and replaced with a desired tool head, subsequently, after the replacement of the tool head 50, the elastic fastening element 132 will be rotated to the limiting position, that is to say, the elastic fastening element 132 will be rotated to make the first groove 1321 be aligned with the radial inserting hole 111 of the inserting groove 11, since the accommodation space of the first groove 1321 is smaller than the accommodation space of the second groove 1322, the locating steel ball 131 will be pushed toward the inserting groove 11 to push against and limit the tool head 50 inserted in the inserting groove 11 to prevent the tool head 50 from dropping off, by such an arrangement, the screwing operation can be performed. Furthermore, the working end 10 is formed with the engaging opening 12 in communication with the inserting groove 11, and the inner diameter of engaging opening 12 is slightly bigger than the outer diameter of the head portion of the screw 71 to be screwed by the tool head 50, so that the screw can be engage in the engaging opening 12 during the screwing operation, avoiding the disengagement of the tool head from the head portion of the screw 71 due to quick rotation.

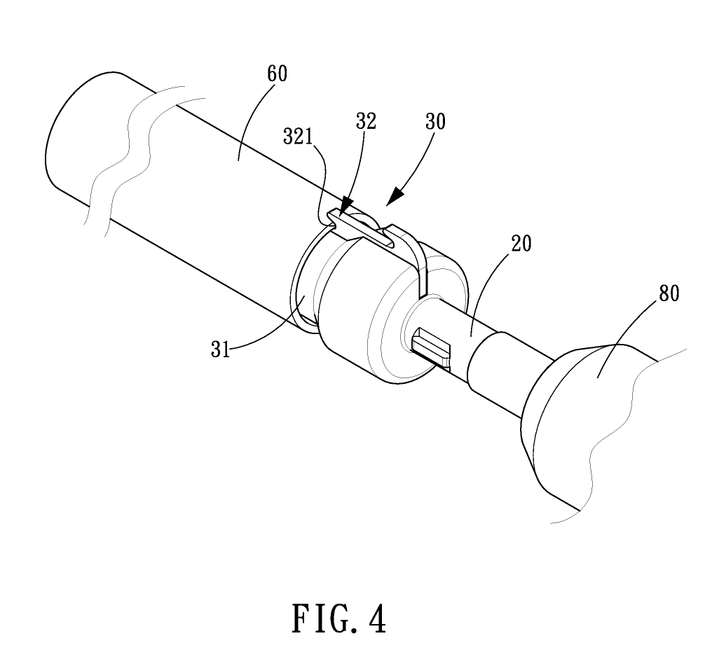

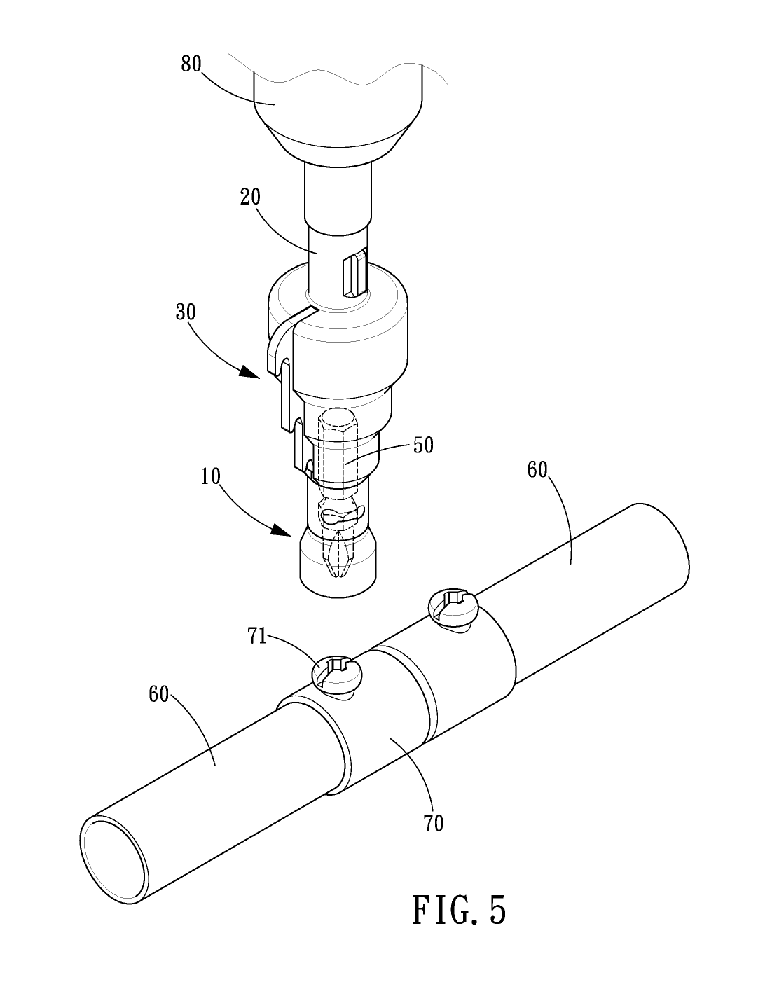

Referring to FIGS. 4-5, when the present invention is used to deburr the raw edge of a cutting end of a pipe element 60, the engaging cylinders 31 of the deburring portion 30 will be engaged on the pipe element 60 in such a manner that the scraping opening 321 of the deburring element 32 is pushed against the circumference of the pipe element 60, and then the power tool 80 will be used to drive the pipe deburrer with replaceable tool head of the present invention to rotate to deburr the circumference of the pipe element 60 through the scraping opening 321, removing the raw edge. In addition, if two pipe elements 60 need connecting together through a connecting assembly 70 after being deburred, the working end 10 of the pipe deburrer with replaceable tool head of the present invention will be directly used to screw the screw 71 of the connecting assembly 70.

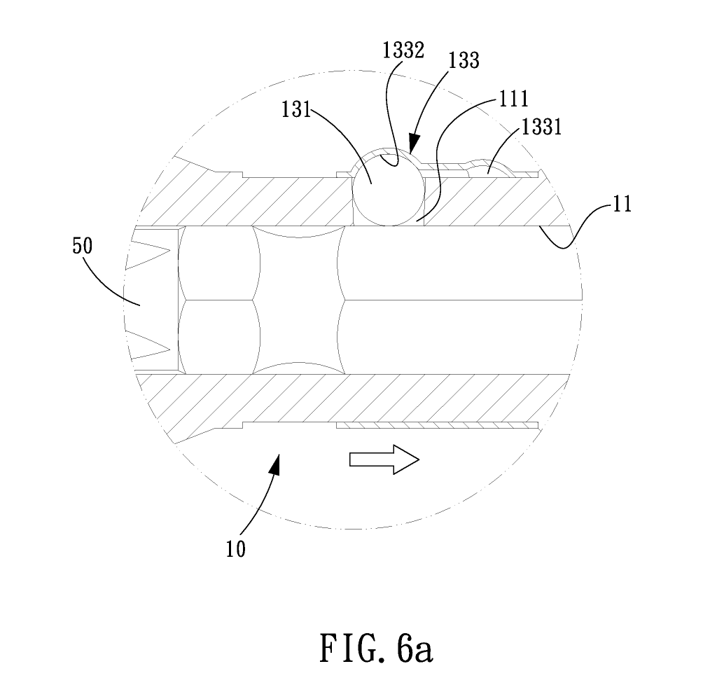

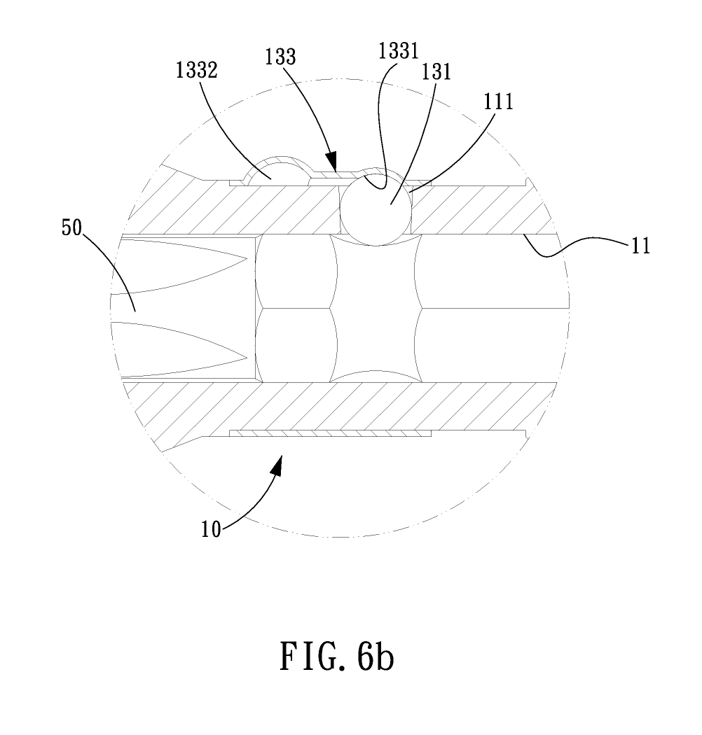

Referring to FIGS. 6a and 6b, in another embodiment of the present invention, the control element 13 of the present invention can also include a locating steel ball 131 which is located in the radial inserting hole 111 and has a diameter bigger than that of the radial inserting hole 111, and a sliding sleeve 133 being slidably mounted outside the inserting groove 11. The sliding sleeve 133 is formed in an inner surface thereof with a third groove 1331 and a fourth groove 1332, and the third groove 1331 is smaller than the fourth groove 1332. The sliding sleeve 133 is shifted between the limiting position where third groove 1331 is aligned with the radial inserting hole 111 to allow the locating steel ball 131 to be pushed against by the third groove 1331 to limit the tool head 50 and the replacing position where the fourth groove 1332 is aligned with the radial inserting hole 111 to allow the locating steel ball 131 to displace toward the fourth groove 1332 to release the tool head 50.

Since the function of the present embodiment is the same as the above-mentioned embodiment, further explanations will be omitted herein.

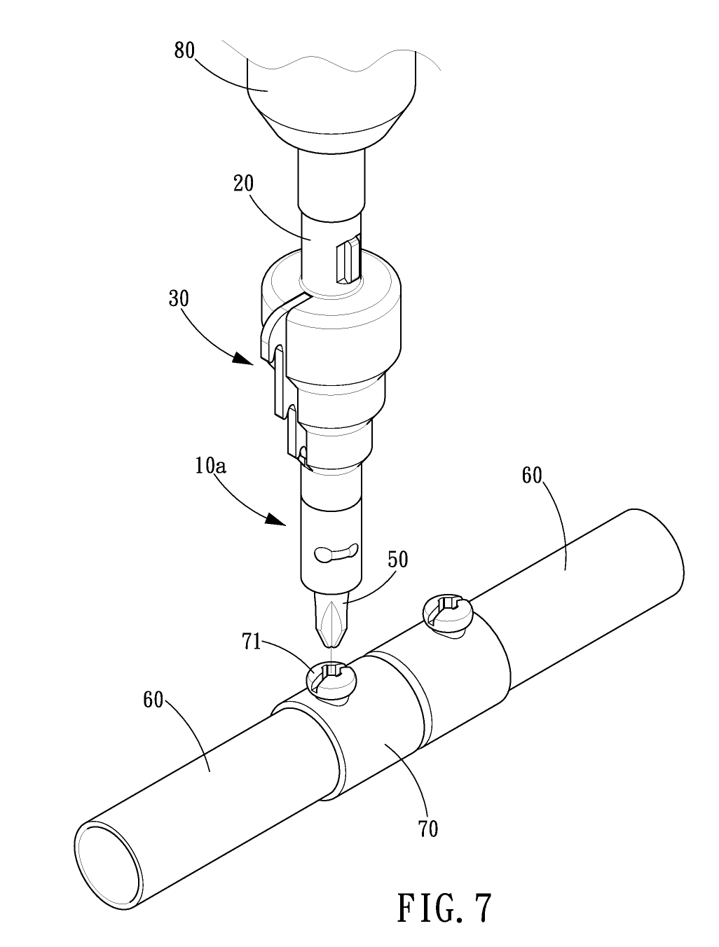

Moreover, as shown in FIG. 7, in another embodiment of the present invention, the tool head 50 can also protrude out of the working end 10a, and it can also perform the screwing operation.

Hence, the working end of the present invention is designed to facilitate replacement of tool head, so that the tool head can be replaced directly as desired according to the types of the screwing elements used by the connecting assembly, and the control element can be used to make the tool head be engaged into or disengaged from the inserting groove of the working end, improving the convenience in use, increasing the working efficiency while reducing the tool cost.

While we have shown and described various embodiments in accordance with the present invention, it is clear to those skilled in the art that further embodiments may be made without departing from the scope of the present invention.

What is claimed is:

1. A pipe deburrer with replaceable tool head, comprising a working end and an assembling end, between the working end and the assembling end being formed a deburring portion, the working end including an inserting groove for insertion of the tool head, the deburring portion including plural different sized engaging cylinders, and the respective engaging cylinders being arranged from the working end to the assembling end in diameter order from smallest to biggest, each of the engaging cylinders being provided with a deburring element at a side thereof, and each of the deburring elements being formed with a scraping opening, the assembling end being assembled to a power tool.

2. The pipe deburrer with replaceable tool head as claimed in claim 1, wherein the working end is provided with a control element, a first end of the control element extends out of the working end, a second end of the control element extends into the inserting groove and is allowed to engage with or disengage from the tool head in the inserting groove.

3. The pipe deburrer with replaceable tool head as claimed in claim 1, wherein the working end is formed with an engaging opening at an opening of the inserting groove, an inner diameter of the engaging opening is bigger than an outer diameter of a head portion of a screw screwed by the tool head.

4. The pipe deburrer with replaceable tool head as claimed in claim 2, wherein the inserting groove is formed with a radial inserting hole, and the control element of the working end includes a locating steel ball which is located in the radial inserting hole and has a diameter bigger than a diameter of the radial inserting hole, and an elastic fastening element which is rotatably mounted outside the inserting groove, the elastic fastening element is formed in an inner surface thereof with a first groove and a second groove, and the first groove is smaller than the second groove, the elastic fastening element is shifted between a limiting position where the first groove is aligned with the radial inserting hole to allow the locating steel ball to be pushed against by the first groove to limit the tool head and a replacing position where the second groove is aligned with the radial inserting hole to allow the locating steel ball to displace toward the second groove to release the tool head.

5. The pipe deburrer with replaceable tool head as claimed in claim 4, wherein the elastic fastening element is C-shaped.

6. The pipe deburrer with replaceable tool head as claimed in claim 4, wherein the elastic fastening element is U-shaped.

7. The pipe deburrer with replaceable tool head as claimed in claim 2, wherein the inserting groove is formed with a radial inserting hole, and the control element of the working end includes a locating steel ball which is located in the radial inserting hole and has a diameter bigger than a diameter of the radial inserting hole, and a sliding sleeve being slidably mounted outside the inserting groove, the sliding sleeve is formed in an inner surface thereof with a third groove and a fourth groove, and the third groove is smaller than the fourth groove, the sliding sleeve is shifted between a limiting position where third groove is aligned with the radial inserting hole to allow the locating steel ball to be pushed against by the third groove to limit the tool head and a replacing position where the fourth groove is aligned with the radial inserting hole to allow the locating steel ball to displace toward the fourth groove to release the tool head.
